(19) United States
(12) Patent Application Publication
(10) Pub. No.: US 2013/0038506 A1
(43) Pub. Date: Feb. 14, 2013

(54) PLANAR ARRAY ANTENNA WITH REDUCED BEAMWIDTH

(71) Applicants: Martin Johansson, Molndal (SE); Bjorn Johannisson, Kungsbacka (SE); Stefan Johansson, Romelanda (SE); Sven Petersson, Savedalen (SE)

(72) Inventors: Martin Johansson, Molndal (SE); Bjorn Johannisson, Kungsbacka (SE); Stefan Johansson, Romelanda (SE); Sven Petersson, Savedalen (SE)

(73) Assignee: Telefonaktiebolaget L M Ericsson(publ), Stockholm (SE)

(21) Appl. No.: 13/643,647

(22) PCT Filed: Apr. 29, 2010
(86) PCT No.: PCT/EP2010/055821

§ 371 Date: Oct. 26, 2012

(51) Int. Cl. H01Q 21/00

(52) U.S. Cl. 343/893

(57) ABSTRACT

The present invention relates to a node (1) in a wireless communication system comprising at least one antenna arrangement (2). The antenna arrangement (2) comprises at least a first antenna part (3) and a second antenna part (4), each antenna part (3, 4, 5) having a longitudinal extension along which extension a corresponding column axis (6, 7, 8) runs. The column axis divides each antenna part in two longitudinal sub-parts. Each antenna part (3, 4, 5) further comprises at least three antenna elements (9, 10, 11, 12, 13, 14) distributed along said column axis (6, 7, 8) and being connected to a corresponding antenna port arrangement (15, 16, 17). For each antenna part (3, 4, 5), at least one (10, 12, 14) of said antenna elements is positioned on said column axis (6, 7, 8), and at least one (9, 11, 13) of said antenna elements is positioned separate from said column axis (6, 7, 8).

### TECHNICAL FIELD

The present invention relates to a node in a wireless communication system comprising at least one antenna arrangement. The antenna arrangement comprises at least a first antenna part and a second antenna part, each antenna part having a longitudinal extension along which a corresponding column axis runs. The column axis divides each antenna part in two longitudinal sub-parts, each antenna part further comprising at least three antenna elements distributed along said column axis and being connected to a corresponding antenna port arrangement.

### BACKGROUND

Planar array antennas are increasingly used in cellular wireless communications systems, in particular in combination with systems based on standards supporting multi-stream radio access, such as LTE (Long Term Evolution). Such planar array antennas are generally configured with a number of parallel columns of radiating elements. Each column has a connection point, a “port”, to which all radiating elements in the column are connected, and signals are on downlink fed to the radiating elements via the respective port.

With systems based on MIMO (Multiple Input Multiple Output) with pre-coding, as used in LTE, more than one port, and hence column, may be associated with a given transmitted signal, and then in particular signals neither intended nor required for the entire area served by the antenna. The resulting radiation pattern for signals associated with multiple columns depends both on the pattern properties of the columns and on the array factor of the planar array, which in turn depends on the array geometry and the column excitations, i.e., code weights.

In sectorized, non-MIMO, systems, the beamwidths of the sector antennas, in particular the horizontal half-power beamwidths for essentially vertically installed linear arrays with individual columns per sector, will have impact on the performance of the system, since the interference situation is strongly related to the radiation pattern properties. The most common macro base station configuration is to have three-sector sites, i.e., three separate cells or sectors, each cell being associated with a specific antenna. Preferably, the horizontal half-power beamwidth of the cell-defining radiation patterns, the sector antenna radiation patterns, should be around 65 degrees for optimized performance in interference-limited scenarios.

A similar situation exists in systems with beamforming, which is the effect of coherent addition of signals from different planar array antenna columns produced by pre-coding, in particular for users near the sector borders. The interference situation is strongly dependent on the half-power beamwidths of the columns of the planar array for users near the sector border. This is particularly relevant for conventional planar arrays, which have 0.5 wavelengths column separation to avoid problems with grating lobes.

The half-power beamwidths of radiation patterns from each individual column in conventional planar array antennas, i.e., when feeding the port associated with the corresponding column, is typically significantly wider than 65 degrees. This means that the sector border signal-to-interference performance of cellular systems at multi-sector sites employing planar array antennas may become worse than would have been the case if the columns had produced patterns with 65 degrees half-power beamwidths, due to the reduced spatial filtering effect of the wider column radiation patterns of planar array antennas.

To achieve half-power beamwidths on the order of 65 degrees, conventional planar array antennas need to have column spacings significantly wider that half a wavelength, a spacing of at least approximately 0.7 wavelength is often required. This means that the desired 65-degree half-power beamwidth comes at the cost of an antenna with much larger total size. In the case of a four-column antenna, the width increases from about two wavelengths to three wavelengths, a 50% increase.

WO 0237610 discloses an array antenna comprising column antennas which are inclined in a sideways direction in relation to the horizontal plane in order to obtain a narrower antenna beam in the horizontal direction.

However, the array antenna according to WO 0237610 is vertically asymmetric and the same beam has different azimuth pointing directions for different azimuth cuts depending on viewed elevation angle. Further, the described array antenna according to WO 0237610 does not get increased antenna gain even when the azimuth beamwidth is reduced as an effect of the inclination. It is also relatively bulky.

There is thus a demand for an array antenna where the half-power beamwidths of radiation patterns from each individual column is reduced, without the drawbacks of prior solutions.

### SUMMARY

The object of the present invention is to provide an array antenna where the half-power beamwidths of radiation patterns from each individual column is reduced, without the drawbacks of prior solutions.

This object is obtained by means of a node in a wireless communication system comprising at least one antenna arrangement. The antenna arrangement comprises at least a first antenna part and a second antenna part, each antenna part having a longitudinal extension along which a corresponding column axis runs. The column axis divides each antenna part in two longitudinal sub-parts, each antenna part further comprising at least three antenna elements distributed along said column axis and being connected to a corresponding antenna port arrangement. For each antenna part, at least one of said antenna elements is positioned on said column axis, and at least one of said antenna elements is positioned separate from said column axis. In this way, the antenna elements of each antenna part are distributed in a direction perpendicular to the column axis as well.

According to one example, the antenna elements are dual polarized.

According to another example, each antenna part comprises the same number of antenna elements.

According to another example, for each antenna element that is positioned separate from said column axis, the separate position corresponds to a certain distance from the column axis, where every such certain distance either is equal to, or different from, any other certain distance.

According to another example, the antenna elements are positioned equidistantly along each column axis

According to another example, the number of antenna elements for each antenna part is equal.

Other examples are evident from the dependent claims.

A number of advantages are provided by means of the present invention. Mainly, reduced azimuth half-power beamwidth is obtained by changing relatively few parameters and without affecting the size and other radiation pattern characteristics.

### BRIEF DESCRIPTION OF THE DRAWINGS

The present invention will now be described more in detail with reference to the appended drawings, where:

FIG. 1 shows a node in a wireless communication system;

FIG. 2 shows an antenna arrangement according to a first example of the present invention;

FIG. 3 shows an antenna arrangement according to a second example of the present invention;

FIG. 4 shows an antenna arrangement according to a third example of the present invention; and

FIG. 5 shows an antenna arrangement according to a fourth example of the present invention.

### DETAILED DESCRIPTION

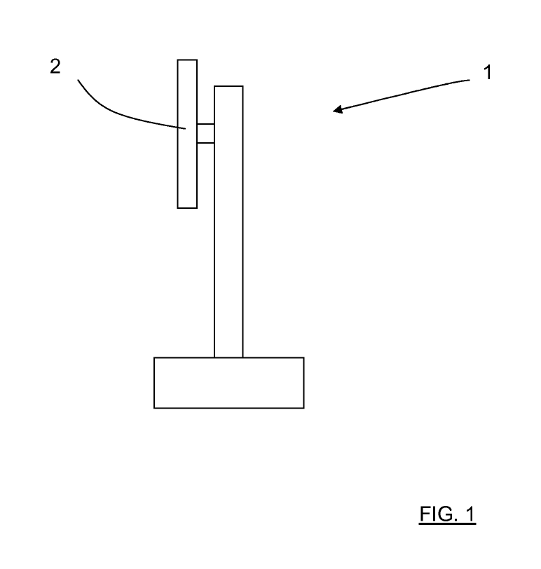

With reference to FIG. 1, there is a node 1 in a wireless communication system comprising an antenna arrangement 2.

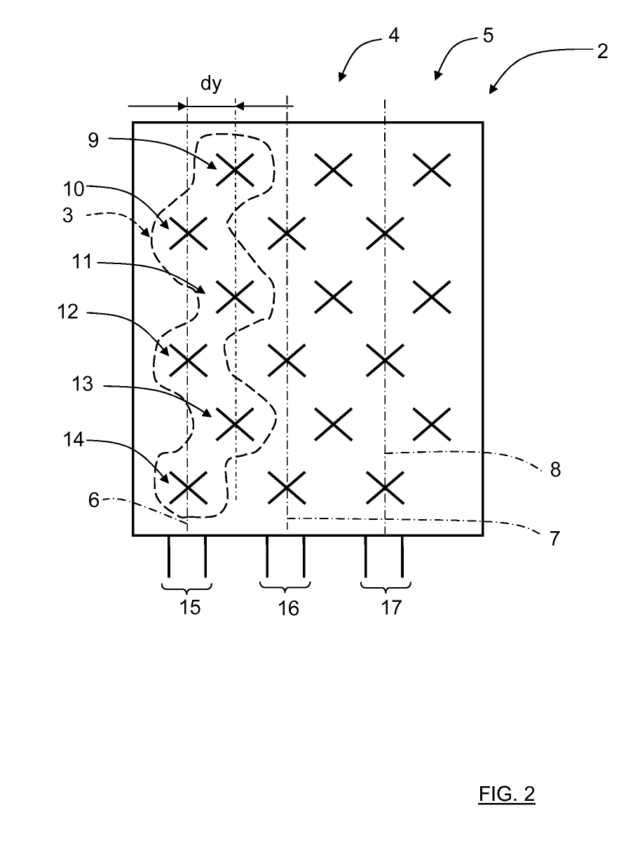

With reference to FIG. 2, showing a first example, the antenna arrangement 2 comprises a first antenna part 3, a second antenna part 4 and a third antenna part 5, where each antenna part 3, 4, 5 has a longitudinal extension along which a corresponding first column axis 6, second column axis 7 and third column axis 8 runs. The first antenna part 3 is specially denoted with a dashed line since the first antenna part will be used for describing the present invention, while of course the present invention is applied on all antenna parts 3, 4, 5; this will be the case for the following examples as well.

Each column axis 6, 7, 8 divides each antenna part 3, 4, 5 in two longitudinal sub-parts. This means that each column axis 6, 7, 8 is placed somewhere within each antenna part, at such a position that each antenna part 3, 4, 5 is longitudinally divided into two parts, namely said two sub-parts.

The first antenna part 3 comprises a first antenna element 9, a second antenna element 10, a third antenna element 11, a fourth antenna element 12, a fifth antenna element 13 and a sixth antenna element 14, which antenna elements are distributed along the first column axis 6.

The antenna elements 9, 10, 11, 12, 13, 14 are connected to a corresponding antenna port arrangement 15 via a feeding network. The antenna elements 9, 10, 11, 12, 13, 14 are in this example, and also in the following examples, schematically shown as dual polarized antenna elements with ±45° polarization relative to the column axes 6, 7, 8.

The second antenna part 4 and third antenna part 5 comprises corresponding antenna elements with a corresponding configuration along the corresponding column axes 7, 8, these antenna elements not being specially denoted in FIG. 2 for reasons of clarity. This will be the case for the following examples as well. The antenna element of the second antenna part 4 and third antenna part 5 are connected to corresponding antenna port arrangements 16, 17 in the same way as the antenna elements 9, 10, 11, 12, 13, 14 of the first antenna part 3.

According to the present invention, for the first antenna part 3, the second antenna element 10, the fourth antenna element 12 and the sixth antenna element are positioned on the first column axis 6 and the first antenna element 9, the third antenna element 11 and the fifth antenna element 13 are positioned at a certain distance dy from the first column axis 6. The same configuration is applied for the second antenna part 4 and the third antenna part 5.

Generally, this example is based on having every second element within each antenna part 3, 4, 5 column systematically offset said certain distance dy from the respective column axis 6, 7, 8, the same offset dy being applied to corresponding elements in all antenna parts 3, 4, 5, all antenna parts 3, 4, 5 having the same number of elements. In this way, the antenna elements of each antenna part 3, 4, 5 are distributed in a direction perpendicular to the respective column axis 6, 7, 8.

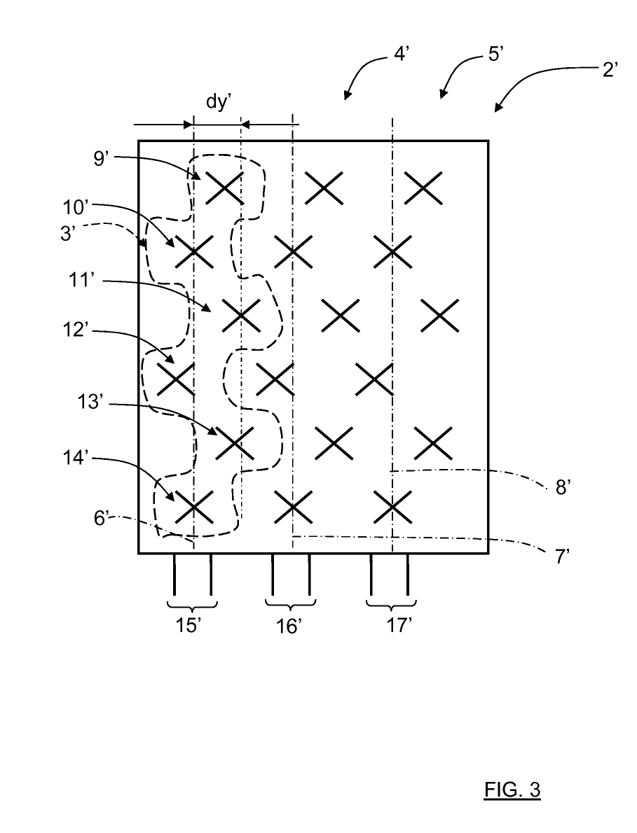

A second example according to the present invention is shown in FIG. 3. In the same way as in the first example there is an antenna arrangement 2′ which comprises a first antenna part 3′, a second antenna part 4′ and a third antenna part 5′, where each antenna part 3′, 4′, 5′ has a longitudinal extension along which corresponding first, second and third column axes 6′, 7′, 8′ run.

The first antenna part 3′ comprises a first antenna element 9′, a second antenna element 10′, a third antenna element 11′, a fourth antenna element 12′, a fifth antenna element 13′ and a sixth antenna element 14′, which antenna elements are distributed along the first column axis 6′.

In the same way as in the first example, the second antenna part 4′ and third antenna part 5′ comprise corresponding antenna elements with a corresponding configuration along the corresponding column axes 7′, 8′.

All antenna elements are connected to corresponding antenna port arrangements 15′, 16′, 17′ via feeding networks.

In accordance with the present invention, in this second example the second antenna element 10′ and the sixth antenna element 14′ are positioned on the first column axis 6′, and each one of the other antenna elements are positioned at a certain element-specific distance dyₙ from the first column axis 6′, where in this example the third antenna element 11′ is positioned at a certain distance dy′ from the first column axis 6′. The same configuration is applied for the second antenna part 4′ and the third antenna part 5′.

Generally, this example is based on having an antenna arrangement having n antenna elements in each antenna part, where every element n within a certain antenna part is offset an element-specific distance dyₙ from a respective column axis, the same offset being applied to corresponding elements in all antenna parts, all antenna parts having the same number of elements. At least one antenna element, but not all, is placed on the respective column axis 6′, 7′, 8′, which means that for these antenna elements the offset dyₙ equals zero. In this way, the antenna elements of each antenna part 3′, 4′, 5′ are distributed in a direction perpendicular to the respective column axis 6′, 7′, 8′.

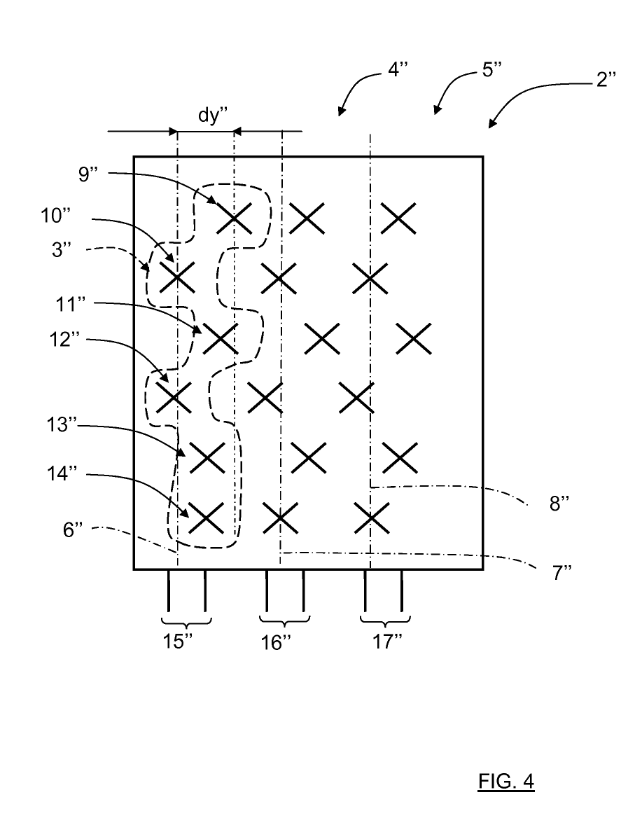

A third example according to the invention is shown in FIG. 4. In the same way as in the first and second example there is an antenna arrangement 2″ which comprises a first antenna part 3″, a second antenna part 4″ and a third antenna part 5″, where each antenna part 3″, 4″, 5″ has a longitudinal extension along which corresponding first, second and third column axes 6″, 7″, 8″ run.

The first antenna part 3″ comprises a first antenna element 9″, a second antenna element 10″, a third antenna element 11″, a fourth antenna element 12″, a fifth antenna element 13″ and a sixth antenna element 14″, which antenna elements are distributed along the first column axis 6″.

In the same way as in the first and second example, the second antenna part 4″ and third antenna part 5″ comprise corresponding antenna elements with a corresponding configuration along the corresponding column axes 7″, 8″.

All antenna elements are connected to corresponding antenna port arrangements 15″, 16″, 17″ via feeding networks.

In accordance with the present invention, in this third example the second antenna element 10″ is positioned on the first column axis 6″, and each one of the other antenna elements are positioned at a certain element-specific distance dyₙₘ from the first column axis 6″, where in this example the first antenna element 9″ is positioned at a certain distance dy″ from the first column axis 6″. However, the particular configurations differ between antenna parts 3″, 4″ 5″ within the general configuration according to the below, as evident from FIG. 4.

Generally, this example is based on having every element n in antenna part m offset an element-specific and column-specific distance dyₙₘ from a respective column axis, all antenna parts having the same number of elements. For each antenna part, at least one antenna element, but not all, is placed on the respective column axis 6″, 7″, 8″, which means that for these antenna elements the offset dyₙₘ equals zero. In this way, the antenna elements of each antenna part 3″, 4″, 5″ are distributed in a direction perpendicular to the respective column axis 6″, 7″, 8″.

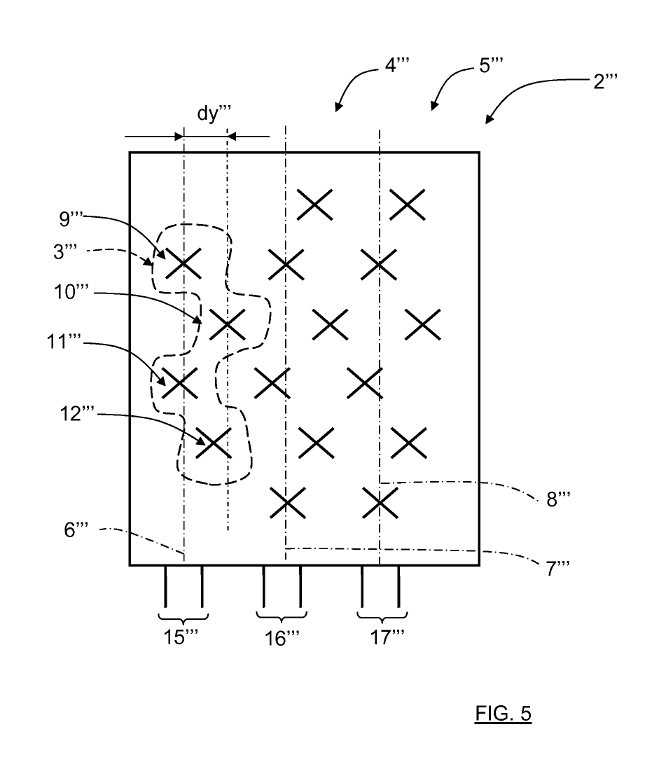

A fourth example according to the invention is shown in FIG. 5. In the same way as in the first, second and third example there is an antenna arrangement 2′″ which comprises a first antenna part 3′″, a second antenna part 4′″ and a third antenna part 5′″, where each antenna part 3′″, 4′″, 5′″ has a longitudinal extension along which corresponding first, second and third column axes 6′″, 7′″, 8′″run.

The first antenna part 3′″comprises a first antenna element 9′″, a second antenna element 10′″, a third antenna element 11′″ and a fourth antenna element 12″′, which antenna elements are distributed along the first column axis 6″.

The second antenna part 4′″ and third antenna part 5′″ also comprise antenna elements along the corresponding column axes 7′″, 8″. However, the number of antenna elements in each one of the second antenna part 4′″ and third antenna part 5′″ is six, which differs from the number of antenna elements in the first antenna part 3″.

All antenna elements are connected to corresponding antenna port arrangements 15″′, 16″′, 17′″ via feeding networks.

In accordance with the present invention, in this fourth example the first antenna element 9′″ is positioned on the first column axis 6′″, and each one of the other antenna elements are positioned at a certain element-specific distance dyₙₘ from the first column axis 6′″, where in this example the second antenna element 10″′ is positioned at a certain distance dy′″ from the first column axis 6″. However, the particular configurations differ between antenna parts 3′, 4′ 5′ within the general configuration according to the below, as evident from FIG. 5. Furthermore, the number of antenna elements differs for the antenna parts 3′″, 4′″, 5′″, in this example the first antenna part comprises four antenna elements and the other antenna parts 4′″, 5′″ comprise six antenna elements each.

Generally, this example is based on having every element n in antenna part m offset an element-specific and column-specific distance dyₙₘ from a respective column axis as in the third example, where at least one antenna part comprises a different number of antenna elements than the other antenna parts.

The number of elements per column can be either even or odd in all examples, both herein presented and otherwise derivable by a person skilled in the art.

It should be understood that the letter n generally denotes a certain antenna element and that the letter m generally denotes a certain antenna part.

The antenna parts disclosed above correspond to antenna columns in prior art antenna arrangements. The term antenna part has been used in order to clarify that the antenna elements are not arranged in traditional columns, but in an offset manner according to the present invention.

The first example which is shown in FIG. 2 provides reduced azimuth half-power beamwidth by a single-parameter offset value for every second antenna element within each antenna part of an antenna arrangement. Using a single parameter to control the azimuth beamwidth facilitates the antenna design, since the available parameter space is limited to one dimension, which is advantageous in terms of requiring very modest computer resources during antenna syntheses. It also offers hardware advantages, since periodic, alternating, offsets allow mechanical solutions that may be re-used over the entire antenna arrangement.

The second example which is shown in FIG. 3 provides reduced azimuth half-power beamwidth by multiple-parameter offset values, one for each antenna element within a an antenna part. Using a number of parameters, equal for all antenna parts but specific for each antenna element within an antenna part to control the beamwidth, allows the antenna design to be influenced by both elevation and azimuth pattern performance measures.

The second example also allows a relatively simple antenna design phase, since the dimensions of the available parameter space is limited by the number of antenna elements per antenna part, which is advantageous in terms of requiring modest computer resources during antenna syntheses. It also offers hardware advantages, since systematic offsets of all elements in a row allow mechanical solutions that may be re-used over the entire antenna arrangement. Note that the element spacing within an antenna part, that is, the element spacing along respective first, second and third column axes 6′, 7′, 8′ does not have to be uniform.

The third example which is shown in FIG. 4 provides reduced azimuth half-power beamwidth by multiple-parameter offset values, one for each element within each column of an antenna arrangement. Using a number of parameters equal to, or a significant fraction of the total number of elements in the antenna arrangement to control the beamwidth, allows the design to be influenced by both elevation and azimuth pattern performance measures, just as in the second example, as well as by the specific element positions in the antenna arrangement. The latter is important since it allows the antenna designer to take into, and compensate for, mutual coupling effects using also the offset values in the process.

The fourth example which is shown in FIG. 5 corresponds in advantages and complexity to the third example, with the added possibility to have unequal numbers of antenna elements per antenna part.

The present invention is not limited to the examples according to the above, but may vary freely within the scope of the appended claims. For example, the antenna elements may be single polarized, and may be of any suitable design such as patches or dipoles.

The antenna arrangement is preferably in the form of a planar array antenna.

The examples shown are merely examples of different general configurations where the present invention may be applied. The examples shown may be combined, for example the number of antenna elements may differ between the antenna parts for the first example.

The fourth example which is shown in FIG. 5 not only adds the possibility to have unequal numbers of antenna elements per antenna part, but also to have unequal numbers of antenna elements per polarization or a combination of both.

The antenna elements in each antenna part may be separated with the same distance along the corresponding column axis, but may also be separated with different distances along the corresponding column axis. The antenna elements in an antenna part may thus be positioned equidistantly along its column axis or non-equidistantly along its column axis.

For all the examples, and in general for the present invention, each node comprises at least one antenna arrangement 2, each antenna arrangement 2 comprising at least two antenna parts 3, 4. Each antenna part 3, 4, 5 comprises at least three antenna elements. For all examples, for a certain antenna part, at least one of the antenna elements is positioned on the column axis 6, 7, 8, and at least one of the antenna elements is positioned separate from said column axis 6, 7, 8.

In the examples discussed, at least one antenna element antenna element is positioned at a certain distance dy, dy′, dy″, dy′″ from a column axis. It is to be understood that the reference signs dy, dy′, dy″, dy′″ generally may relate to the distance that any antenna element is positioned from a column axis, where applicable.

1. A node in a wireless communication system, comprising:
at least one antenna arrangement, the antenna arrangement comprising:
a first antenna part having a first longitudinal extension along which a first column axis runs, said first column axis dividing the first antenna part in two longitudinal sub-parts; and
a second antenna part having a second longitudinal extension along which a second column axis runs, said second column axis dividing the second antenna part in two longitudinal sub-parts, wherein
the first antenna part further comprises a first antenna element, a second antenna element, and a third antenna element, each of said first, second and third antenna elements being distributed along said first column axis and being connected to a first antenna port arrangement,
the second antenna part further comprises a fourth antenna element, a fifth antenna element, and a sixth antenna element, each of said fourth, fifth and sixth antenna elements being distributed along said second column axis and being connected to a second antenna port arrangement,
the first antenna element is positioned on said first column axis,
the fourth antenna element is positioned on said second column axis,
the second antenna element is positioned separate from said first column axis with a certain distance (d1), wherein d1 is greater than zero,
the fifth antenna element is positioned separate from said second column axis with said certain distance (d1).

2. The node according to claim 1, wherein each of said recited antenna elements is dual polarized.

3. The node according to claim 1, wherein the first antenna part has the same number of antenna elements as the second antenna part.

4. The node according to claim 1, wherein
the third antenna element is positioned on said first column axis,
the third antenna element is positioned further along the first column axis than the second antenna element,
the second antenna element is positioned further along the first column axis than the first antenna element,
the sixth antenna element is positioned on said second column axis, and
the sixth antenna element is positioned further along the second column axis than the fifth antenna element, and
the fifth antenna element is positioned further along the second column axis than the fourth antenna element.

5. The node according to claim 4, wherein
the first antenna part further comprises a seventh antenna element,
the seventh antenna element is positioned separate from said first column axis with a certain distance (d2), wherein d2 is greater than zero,
the second antenna part further comprises an eighth antenna element,
the eighth antenna element is positioned separate from said second column axis with the certain distance (d2).

6. The node according to claim 1, wherein
the first, second, and third antenna elements are positioned equidistantly along the first column axis, and
the fourth, fifth, and sixth antenna elements are positioned equidistantly along the second column axis.

7. The node according to claim 1, wherein
the third antenna element is positioned separate from said first column axis with a certain distance (d2), wherein d2 is greater than zero.

8. The node according to claim 7, wherein d2 is equal to d1.

9. The node according to claim 1, wherein
the antenna arrangement further comprises a third antenna part having a third longitudinal extension along which a third column axis runs, said third column axis dividing the third antenna part in two longitudinal sub-parts,
the third antenna part further comprises a seventh antenna element, an eighth antenna element, and a ninth antenna element, each of said seventh, eighth and ninth antenna elements being distributed along said third column axis and being connected to a third antenna port arrangement,
the seventh antenna element is positioned on said third column axis, the eighth antenna element is positioned separate from said third column axis with the certain distance (d1),
the first column axis is parallel with the second column axis,
the second column axis is parallel with the third column axis,
the distance between the first antenna part and the second antenna part in a direction perpendicular to the first column axis is equal to a distance of d2,
the distance between the second antenna part and the third antenna part in a direction perpendicular to the second column axis is equal to the distance of d2.

10. The node according to claim 9, wherein d2 equals two times d1.
